(19) United States
(12) Patent Application Publication
(10) Pub. No.: US 2012/0169659 A1
(43) Pub. Date: Jul. 5, 2012

(54) APPARATUS FOR CAPACITANCE SENSOR WITH INTERFERENCE REJECTION AND ASSOCIATED METHODS

(76) Inventor: David R. Welland, Austin, TX (US)

(21) Appl. No.: 13/335,407

(22) Filed: Dec. 22, 2011

Related U.S. Application Data
(63) Continuation-in-part of application No. 12/870,844, filed on Aug. 29, 2010.

(51) Int. Cl. G06F 3/045

(52) U.S. Cl. 345/174

(57) ABSTRACT

A method for interfacing with a capacitive touch screen is disclosed. The method includes charging an internal capacitor in the touch screen, which internal capacitor is disposed proximate a fixed location on the touch screen and is capable of changing in response to a touch at that location on the touch screen. After charging, value of the charge on the internal capacitor is determined in a manner to reduce effects of interference.

### CROSS-REFERENCE TO RELATED APPLICATIONS

This application is a continuation-in-part of, and incorporates by reference in its entirety, U.S. patent application Ser. No. 12/870,844, titled “MULTI-TOUCH RESOLVE MUTUAL CAPACITANCE SENSOR,” filed on Aug. 29, 2010 (Atty. Dkt. 29770). Furthermore, the present application is related to co-pending U.S. patent application Ser. No. 12/775,447, filed May 6, 2010 entitled “METHOD AND APPARATUS FOR SCANNING A TOUCHSCREEN WITH MULTI-TOUCH DETECTING USING MASTER/SLAVE DEVICES” (Atty. Dkt. No. 29,953) and U.S. patent application Ser. No. 12/870,849, filed Aug. 30, 2010, entitled “LOW POWER MULTI-TOUCH SCAN CONTROL SYSTEM” (Atty. Dkt. No. CYGL-30,121), which are incorporated by reference herein in their entireties.

### TECHNICAL FIELD

The present invention pertains in general to touch screens and, more particularly, to a touch screen with Multi-Touch Resolve (MTR) capabilities.

### BACKGROUND

Capacitive touch screens have been utilized recently to allow a user to provide a user interface with touch capability on such things as Personal Digital Assistants (PDAs), tablet PCs, etc. These touch screens function by detecting a change in capacitance at a particular location as opposed to a physical interaction with the screen, such as is the case with a stylus based system. With capacitance based touch screens, a finger is typically placed onto the screen which will change the capacitance of a region thereon. This region could be a touch pad or it could be a touch screen array which is comprised of an array of column lines and intersecting row lines. By detecting the capacitance of a row line, for example, a difference in capacitance on a particular row line can be detected, as is also the case with respect to the column line. If just the capacitance of a row line or the capacitance of a column line is utilized as the discriminating factor, an ambiguity may exist when merely detecting the static capacitance on these lines in the presence of multiple touches on the screen. The reason for this is that static capacitance measuring devices merely determine that a particular row line was touched and a particular column line was touched. For two touches, all that is known is that two row lines have been touched and two column lines have been touched, but the exact intersection can not be determined. To rectify this, Multi-Touch Resolve (MTR) techniques have been employed to detect a change in capacitance of the row-to-column capacitance (C_{RCF}). These techniques typically utilize some type of signal that is injected into a row line and coupled across C_{RCF} to a column line. A detector on the column line can detect this signal level. By comparing the signal level in the presence of a touch to the signal level in the absence of a touch, a determination can be made as to the presence of the touch due to a change in the signal level.

### SUMMARY

The disclosure relates in part to apparatus and methods for multi-touch resolve (MTR) and MTR chopper functionality. In one exemplary embodiment, a method for interfacing with a capacitive touch screen includes charging an internal capacitor in the touch screen, which internal capacitor is disposed proximate a fixed location on the touch screen and is capable of changing in response to a touch at that location on the touch screen. of the method further includes determining the charge on the internal capacitor in a manner to reduce effects of interference. In another exemplary embodiment, a method of determining the value of a capacitance between a row line and a column line in a capacitive touch screen comprising a plurality of intersecting row and column lines includes driving one of the row or column lines to a first voltage, with an intersecting one of a column or row lines being coupled to a node external to the touch screen to charge a capacitance at the intersection. The external node has a reference capacitor disposed thereon charged to a reference voltage. The method further includes driving the one of the row or column lines to a second voltage higher than the first voltage, and allowing charge to be transferred between the capacitance at the intersection and the reference capacitor. The method also includes determining the value of the change of the charge on the reference capacitor. In yet another exemplary embodiment, a capacitance value sensor is disclosed for determining a capacitance value corresponding to the value of a display capacitance in a touch screen display having intersecting first lines and second lines, with the display capacitance disposed at the intersection of one of the first and second lines. The capacitor value sensor includes a driver that drives the one of the first lines to drive one plate of the display capacitance from a first voltage to a second voltage level larger than the first voltage, and a capacitance sense circuit. The capacitance sense circuit includes a reference capacitor, having one plate thereof coupled to a voltage node; a charging circuit; charge transfer circuitry; and a charge detect circuit. The charging circuit operates in a first mode to couple the voltage node to the one of the second lines with the driver operating to drive the one plate of the display capacitance to the first voltage level. The charge transfer circuitry operates in a second mode to transfer charge from the display capacitance to the reference capacitor. The charge detect circuit operates in a third mode to determine the change in charge on the reference capacitor after transfer of charge thereto from the display capacitance, and to output a value for such change in charge that corresponds to the value of the display capacitance.

### BRIEF DESCRIPTION OF THE DRAWINGS

For a more complete understanding, reference is now made to the following description taken in conjunction with the accompanying Drawings in which:

FIG. 1 illustrates a diagrammatic view of a scan control IC interfaced with a display;

FIG. 2 illustrates a more detailed diagram of the scan control IC illustrating the two scan interfaces associated therewith;

FIGS. 3a, 3b, and 3c illustrate a more detailed diagram of the overall scan control IC;

FIG. 4 illustrates a schematic of the I/O pad;

FIG. 5 illustrates a diagrammatic view of a touch panel illustrating the row-to-column capacitance at the interface with the ADCs;

FIG. 6 illustrates a more detailed diagram of the row and column intersections for a touch screen and the capacitance associated therewith;

FIG. 7 illustrates a circuit diagram for the voltage sampling step of the conversion operation;

FIG. 8 illustrates a basic diagram for the ADCs associated with the MTR function;

FIG. 9 illustrates a timing diagram for the MTR operation and the three phases thereof;

FIG. 10 illustrates the auto zero configuration for the ADC and the MTR;

FIG. 11 illustrates the transfer mode for the ADC and the MTR;

FIG. 11a illustrates an alternate view of the embodiment of FIG. 10;

FIG. 12 illustrates the conversion phase for the ADC of the MTR block;

FIG. 13 illustrates a detail of the SAR conversion operation;

FIG. 14 illustrates a basic diagram for the ADCs associated with the MTR chopper function;

FIG. 15 illustrates the auto zero configuration for the ADC and the MTR chopper; and

FIG. 16 illustrates the transfer mode for the ADC and the MTR chopper.

### DETAILED DESCRIPTION

Referring now to the drawings, wherein like reference numbers are used herein to designate like elements throughout, the various views and embodiments of a touch screen scanning architecture are illustrated and described, and other possible embodiments are described. The figures are not necessarily drawn to scale, and in some instances the drawings have been exaggerated and/or simplified in places for illustrative purposes. One of ordinary skill in the art will appreciate the many possible applications and variations based on the following examples of possible embodiments.

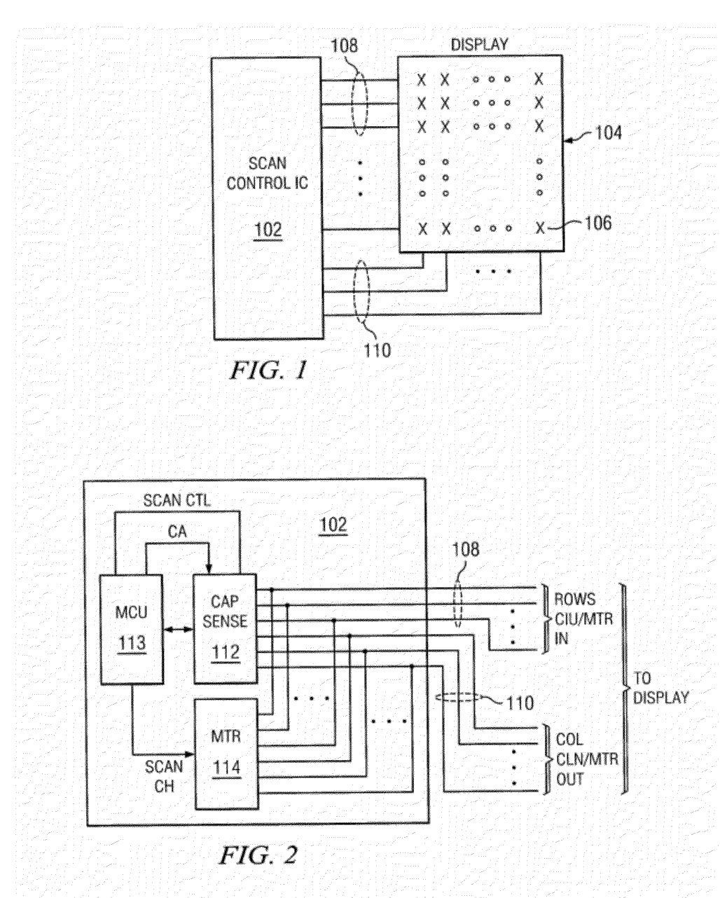

Referring now to FIG. 1, there is illustrated a diagrammatic view of a scan control IC 102 that is interfaced with a touch screen 104 that can be used by itself or in conjunction with a display as an overlay. The touch screen 104 is a touch screen having a plurality of distributed capacitors 106 disposed at intersections of columns and rows. There are a plurality of rows 108 and a plurality of columns 110 interfaced with the scan control IC. Thus, a row line will be disposed across each row which intersects with a column line on the touch screen surface and these are interfaced with the scan control IC 102. It should be understood that a capacitive touch pad or detection area refers to an area on the touch screen, but will be used to refer to an intersection between a row line and a column line. The term “touch pad” and “intersection” shall be used interchangeably throughout.

Referring now to FIG. 2, there is illustrated a more detailed diagrammatic view of the scan control IC 102. In determining a change in capacitance for a particular row or column line, there can be multiple techniques utilized. The first technique is to merely sense the value of the self capacitance for all or a select one or ones of the row or column lines and then utilize some type of algorithm to determine if the capacitance value has changed and then where that change occurred, i.e., at what intersection of row and column lines. The scan control IC 102 provides this functionality with a capacitive sense block 112. This block 112 functions to determine if a change has occurred in the self capacitance value of the particular row or column line to ground. Another technique is that referred to as a “multi-touch resolve” (MTR) functionality provided by an MTR module 114. This is for sensing changes in the mutual capacitance at the intersection of a row and column line, i.e., the row-to-column capacitance C_{RCF}.

The capacitive sense block capacitive-to digital converter 112 is basically controlled to scan row and column lines and determine the self capacitance thereof to ground. If a change in the self capacitance occurs, this indicates that some external perturbance has occurred, such as a touch. By evaluating the self capacitance values of each of the rows and columns and comparing them with previously determined values, a determination can be made as to where on the touch screen a touch has been made. However, if multiple touches on the touch screen have occurred, this can create an ambiguity. The MTR module 114, as will be described in more detail herein below, operates to selectively generate a pulse or signal on each of the row lines and then monitor all of the column lines to determine the coupling from the row line to each of the column lines. This provides a higher degree of accuracy in determining exactly which intersection of a particular row and column was touched.

Each of the column lines is monitored to determine the value of signal coupled across the row-to-column intersection with the row line being driven by the pulse or signal. Thus, if a pulse or any type of signal is input on a particular row line, for example, the change in the signal coupled across the intersection between that column line and a row line having a finger disposed across the particular intersection will be noticeable since this particular intersection will exhibit the highest change in mutual capacitance. In general, the mutual capacitance across the intersection between row and column lines will actually decrease when a finger is disposed in close proximity thereto. It should be understood that the pulse could be generated on column lines and the row lines sensed, as opposed to the illustrated embodiment wherein the pulse is generated on the column lines and then the row lines sensed, and row and column lines shall be utilized in the description herein in an interchangeable manner. It is noted that for each generation of a pulse, all of the column lines are monitored at substantially the same time depending upon inherent delays in circuitry and the such. This could be facilitated with dedicated analog-to-digital converters for each row/column line or a multiplexed bank of such. As will be described herein below, a pulse input is used in conjunction with a charge transfer technique.

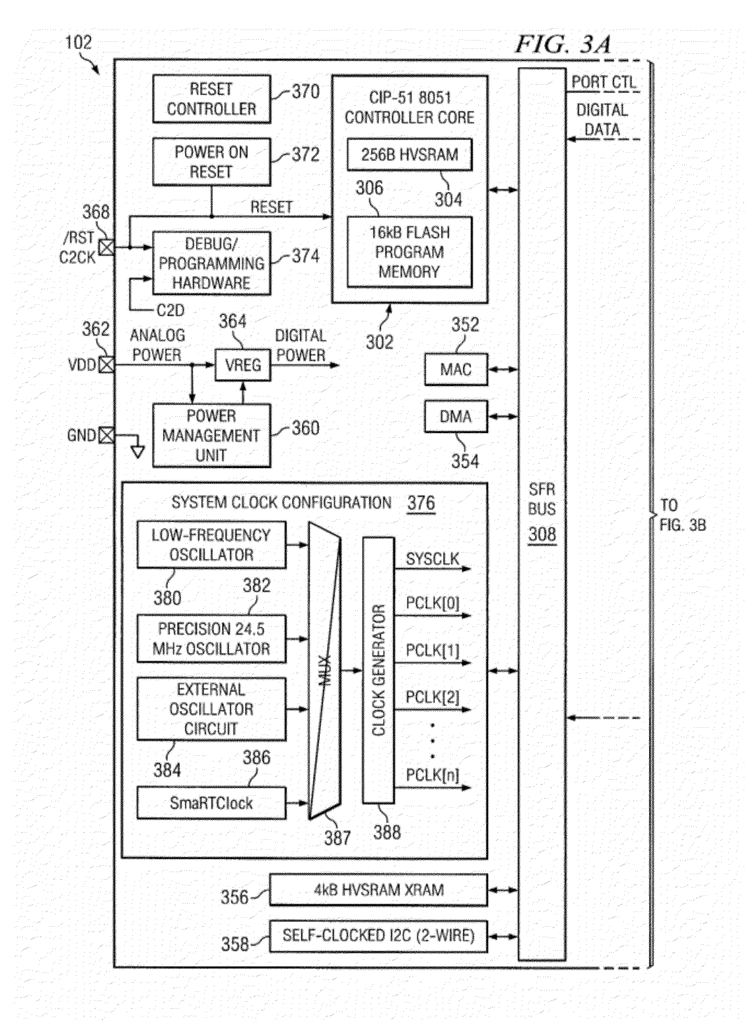

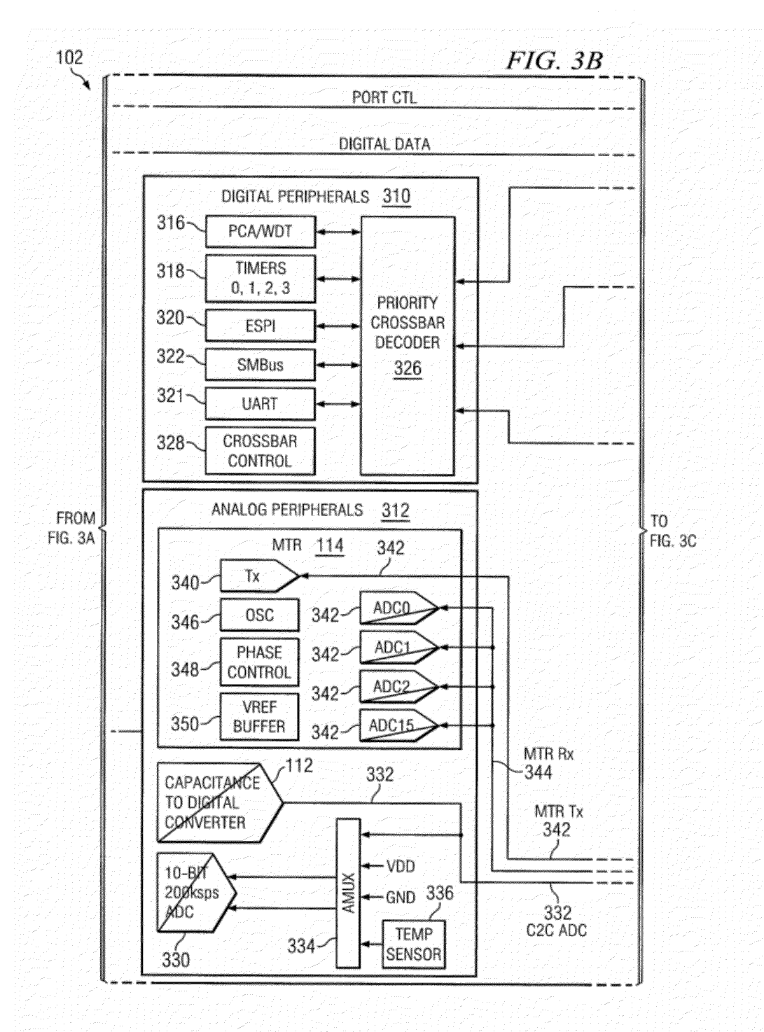

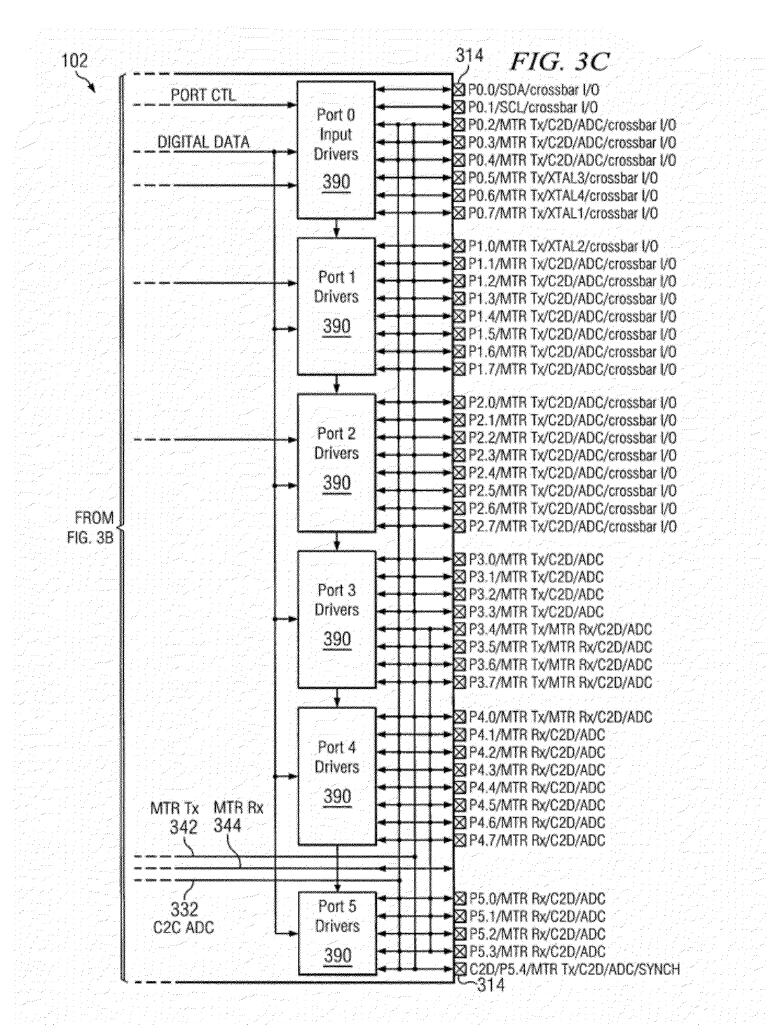

Referring now to FIG. 3a, there is illustrated a more detailed block diagram of the scan control IC 102. At the heart of the scan control IC 102 is an 8051 central processing unit (CPU) 302. The scan control IC 102 is basically a microcontroller unit (MCU) which is described in detail in U.S. Pat. No. 7,171,542, issued Jan. 30, 2007 to the present assignee and entitled RECONFIGURABLE INTERFACE FOR COUPLING FUNCTIONAL INPUT/OUTPUT BLOCKS TO LIMITED NUMBER OF I/O PINS, which is incorporated herein by reference in its entirety. The 8051 processing core 302 includes XRAM 304 and flash memory 306, the flash memory utilized to store program instructions, which memory constitutes non-volatile memory. The 8051 processing core 302 interfaces with various peripheral circuitry on the IC 102 such as contained in a digital peripherals block 310. The interface is provided by a Special Function Register (SFR) bus 308 which allows the processing core 302 to interface with the various peripherals via Special Function Registers (SFRs), these registers being addressable registers within the address spaces of the processing core 302 that allow the processing core 302 to store data therein for use by the digital peripherals and for the peripherals to store processed data or receive data therein for use by the processing core 302. This effectively provides a “gateway” for data back and forth between the various peripherals. The terms CPU, processing core and MCU will be used interchangeably throughout, as the MCU is a combination of the processing core (CPU) 302, memory and peripherals that allow the CPU 302 to carry out the various functions of the overall IC.

The digital peripheral block 310 is one set of peripherals operating in the digital domain and an analog peripheral block 312 provides analog peripherals. These peripherals provide an interface between an interface for the IC 102 to the external world through various external pins. These external or output port pins are illustrated in FIG. 3c and designated by reference numeral 314.

The digital peripheral block 310 includes a watch dog timer block 316, various timers 318, a serial peripheral interface block 320, an SMBus block 322 and a UART block 324. All of these blocks 316-324 are interfaced to a priority crossbar decoder 326. The priority crossbar decoder 326 is operable to be configured by a crossbar control block 328 in order to interface the various peripherals 316-324 with select ones of the output port pins 314. This is described in detail in U.S. Pat. No. 7,171,542, which was incorporated by reference herein above. The priority crossbar decoder 326 is utilized for the digital interface and will allow such things as the UART 324 to be interfaced with select pins on the output port pins 314 and these can be user configured for any pins that are desired to be associated therewith. The SMBus 322 utilizes a 2-wire serial bus interface utilizing a clock and a data line and this clock and data line utilize two pins and these can be configured for any two of the select pins. As described in U.S. Pat. No. 7,171,542, these pins, once assigned, can take priority over other pins.

The analog peripheral block 312 includes the cap sense block 112 and the MTR module 114 in addition to including an analog-to-digital converter (ADC) 330. This ADC 330 is a 10-bit ADC which is interfaced with a CDC/ADC bus or analog line 332, this bus or line 332 also interfaced with the input to the capacitive sense block 112. An analog multiplexer 334 is provided for interface between the ADC 330 and the bus 332 such that it can select the bus 332 or other analog peripherals. The analog inputs interfaceable to the bus 332 are typically scanned inputs such that the ADC 330 can selectively sample the analog values thereon by enabling the I/O pad associated with a desired pin designated as an analog input and convert these to digital values. In addition, the multiplexer 334 allows for sensing of the supply voltage, the ground voltage and a voltage associated with an on-chip temperature sensor 336. This temperature sensor 336 is basically associated with a voltage generated by a band gap generator (not shown) which generates various voltages for the operation of the analog circuitry on the IC 102. This is a conventional circuit that provides temperature stabilized voltage sources. By providing for selection of the temperature input, a temperature measurement can be provided which is utilized, as will be described herein below, for calibration of the MTR module 114. It is also used for other functions which are not described herein.

As will be described in more detail herein below, the MTR module 114 is comprised of a transmitter 340 which is operable to transmit a pulse on a negative going edge. This is provided as a driving signal on a single line bus 341. This can be selectively output to one of multiple pins associated with that functionality by enabling a desired I/O pad as an analog output. Additionally, there are provided dedicated ADCs 342 which each interface with one of 16 different input pins on a bus 344. This comprises the MTR Rx inputs, whereas the bus 341 comprises the MTR Tx output. There are 16 ADCs 342 to allow for simultaneous interface to 16 different MTR Rx inputs such that bus 344 has a width of 16. As will be described herein below, each of these ADCs 342 receives one of the 16 inputs in parallel and processes those values in parallel. These are dedicated to the MTR functionality. It should be understood that less than 16 ADCs 342 could be utilized by multiplexing the operation thereof.

In addition to the transmitter 340 and the receive ADCs 342, there is also provided a peripheral oscillator 346 such that the MTR module 114 is a “self-clocked” peripheral. This self clocking allows the MTR module 114, and other such self clocked analog peripherals, to operate when the digital circuitry including clocking circuitry is asleep. The MTR block could also operate on the system clock. This oscillator 346 utilizes an RC oscillator circuit that can run independently or be synched up with an external clock. However, when this oscillator 346 is running, it is asynchronous with respect to the system clock (described herein below) that is utilized to provide timing for the entire chip when running. During various low power modes, the system clock circuitry is halted or powered down and, as such, for the MTR module 114 to operate and scan a particular touch screen, an internal self contained clock is utilized. This will be described in more detail herein below. There is also provided a phase control 348 for control of different MTR operational phases and a V_{REF} buffer 350. This V_{REF} buffer is utilized to sense a reference voltage, which in the case of the MTR module 114 is the supply voltage, and latch it onto a node or, in other words, “freeze” this value during the operation of the ADC 342 conversion operation in order to remove noise. This will be described in more detail herein below.

The 8051 processing core 302, when performing certain operations, utilizes a Multiply Accumulate Block (MAC) 352 to allow certain multiply and accumulate operations to be carried out in the hardware. Additionally, there is a Direct Memory Access (DMA) block 354 that allows the peripheral units and other peripheral blocks to interface directly with an HVSRAM or XRAM memory 356 through the SFR Bus 308 to allow reading and writing of data therewith out requiring the 8051 processing core 302. Thus, any of the blocks associated with peripheral functions can utilize the DMA 354 to write data to the memory 356 and extract data therefrom. There is also provided a self clocked I2C block 358, which is a self-clocked serial data communication peripheral block that has associated therewith two dedicated pins to allow external chips to interface with the digital portion IC 102. Since this is self-clocked, it can operate when the IC 102 is in a sleep or idle mode. This I2C peripheral block 358 can also interface directly with the memory 356 through the DMA 354 such that an external device can directly read and write to the memory 356 through the I2C peripheral block 358.

There is provided a power management unit (PMU) 360 that is operable to interface with the V_{DD} battery voltage or power supply voltage on a power supply pin 362 in order to provide power to the chip. This is typically provided by a battery. The chip power is divided up into analog power, i.e., unregulated power, and digital power which is provided through a regulator 364. This is an LDO regulator that provides the digital voltage. Typically, the battery voltage can run between 1.8-3.6 volts and this is regulated down to a voltage comparable for operating the digital portion of the chip. The power management unit 360 controls the operation of the regulator 364. This regulator 364 is a regulator that can be powered down during sleep mode. This is described in U.S. patent application Ser. No. 11/865,661, filed Oct. 1, 2007, entitled POWER SUPPLY SYSTEM FOR LOW POWER MCU, which is incorporated herein by reference in its entirety.

In addition to the power management, there is also provided a reset and serial clock input on external pin 368 which is operable to provide for a Reset input and also to allow a serial control clock to be input for data input, debugging, etc. The Reset is controlled by a reset controller 370 and a power on reset block 372. Various debugging programming hardware in block 374 is also provided which is controlled by the C2 Data (CDC) which is received on another input and utilizes the C2 clock signal on pin 368 therefor. The CDC is derived from another input or pin.

All of the system clocks are provided by a system clock block 376. It should be understood that these system clocks are what are utilized for the digital operation and are to be distinguished from the internal clocks and the various self-clocked blocks such as the MTR module 114 and the I2C block 358. The system clocks are comprised of an on-chip, low frequency oscillator 380, a precision oscillator 382, an external oscillator circuit 384 and a smart clock block 386, this smart clock block comprising an RTC clock. This is a 32 kHz clock. Although not illustrated, there is provided an RTC function on the chip which is described in U.S. Pat. No. 7,343,504, issued Mar. 11, 2008 to the present assignee, entitled MICROCONTROLLER UNIT (MCU) WITH RTC, which is incorporated herein by reference in its entirety.

With specific reference to FIG. 3c, there is illustrated a diagrammatic view of the pin out configuration for the output port pins 314. These are the peripheral pins which allow the IC 102 to interface with various external devices such as displays, sensors and control lines. Each of these output port pins 314 is associated with an I/O pad (not shown). This I/O pad allows the output port pin 314 to be configured as a digital input/output pad or as an analog input/output pad. It should be understood that some of the output port pins 314 and the associated I/O pads can be manufactured such that they primarily have either a digital function or an analog function. This is a design choice, but it should be understood that each of the output port pins 314 could be given the functionality to accommodate both analog and digital signals.

When dealing with a digital interface, port drivers or pin interface circuits 390 are provided to interface with the various output port pins 314 when driving a digital value thereto. There are provided six port drivers for port 0, port 1, . . . port 5. As can be seen from the labels, the output port pins 314 associated with port 0, port 1 and port 2 drivers 390 can be associated with the crossbar decoder 326 and, as such, those are the only output port pins 314 that can be interfaced with the digital peripherals in block 310 in this example. However, it can be seen that the bus 341, a single wire bus, for the MTR transmitter 340 can be selectively interfaced to thirty two (32) of the output port pins 314 and, as such, the bus 341 is interfaceable therewith. For the MTR receive function, there is provided a sixteen line MTR Rx bus 342, as there are sixteen MTR ADCs 342. There are provided thirty six output port pins 314 interfaceable with the ADC 330 and thirty nine of the output port pins 314 associated with the CDC capacitive sense function through lines 332, a single line bus. Basically, anything that is associated with the CDC capacitive sense functionality will also be associated with the ADC 330, since they share a common bus 332. Thus, each of these pins will have an analog input capability via the associated I/O pad for selecting such. Although not shown, one of the pins will have a dedicated functionality associated with a SYNC function which is only utilized when multiple ones of the IC 102 are configured in a multi-chip operation and this will be connectable to the MTR Tx bus 341 such that respective pins 314 will be associated therewith.

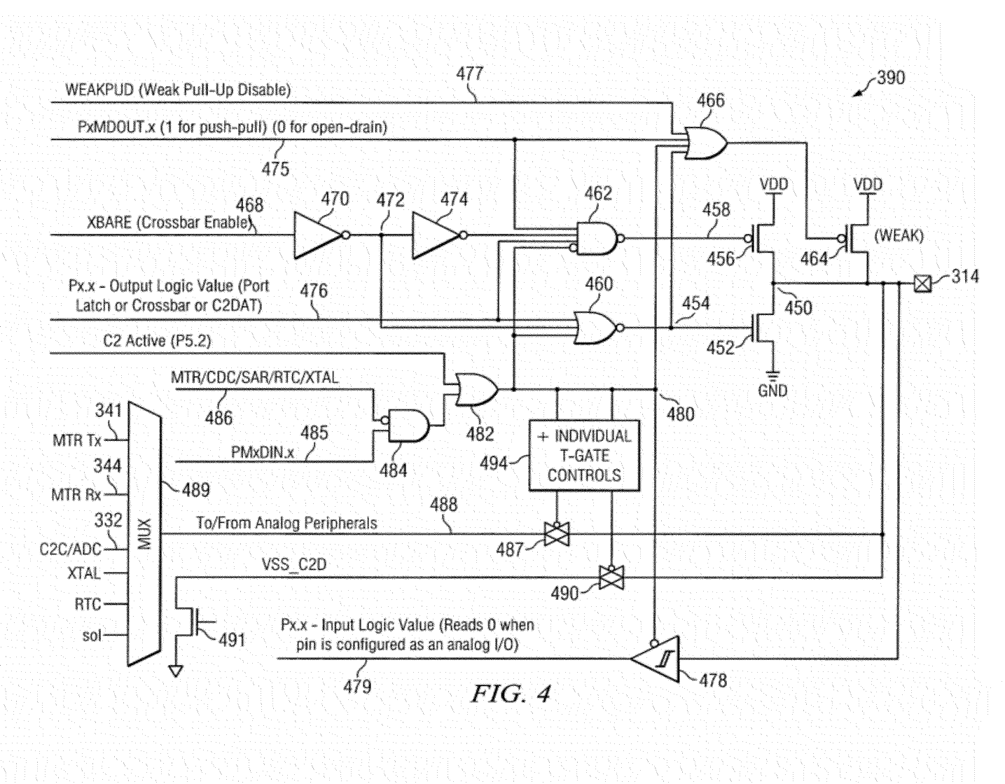

Reference is now made to FIG. 4 where there is shown in functional detail of one pin interface circuit 390, the I/O pad. The other pin interface circuits are constructed and operate in an identical manner, it being understood that some pin interface circuits primarily interface with digital data. While the various logic functions carried out by the pin interface circuit 390 are shown as implemented by traditional logic gates, in practice such functions are carried out by various types of transistor circuits which perform the logic functions. Those skilled in the art can readily devise many different types of transistor circuits to carry out the noted logic functions. Many of the signals coupled to the pin interface circuit 390 are generated by the CPU 302 and some by the analog peripherals 312. In the preferred embodiment, a triplet of the signals is coupled to each pin interface circuit by way of a priority cross-bar decoder. The cross-bar decoder circuit is described in detail in issued patents of the assignee identified as U.S. Pat. No. 6,839,795, issued Jan. 4, 2005 and U.S. Pat. No. 6,738,858, issued May 18, 2004, the subject matter of such patents being incorporated herein by reference.

The pin interface circuit 390 is operable to accommodate a digital I/O function to drive the port with a digital signal or to act as a digital input and receive a digital signal and also to function as an analog I/O port. The digital functionality is facilitated in a driver functionality wherein the output port pin 314 is driven from a node 450 that has the ability to operate as a push-pull node or an open-drain node. In the push-pull operation, an N-channel transistor 452 has the source/drain path thereof connected between node 450 and ground, node 450 connected to the output port pin 314. The gate of transistor 452 is connected to a node 454. A P-channel transistor 456 has the source/drain path thereof connected between node 450 and V_{DD}. The gate of transistor 456 is connected to a node 458. Node 454 is driven by the output of a NOR gate 460 and the gate of transistor 456 is driven by the output of a NAND gate 462. For the open-drain digital output function, there is also provided a weak pull up transistor 464, which is comprised of a P-channel transistor having a source/drain path thereof connecting node 450 and V_{DD} and the gate thereof being driven by an OR gate 466.

When the port is enabled as a digital output, a crossbar encoder enable signal X-BAR is provided as an input on an input node 468. This input 468 drives the input of inverter 470, the output thereof connected to a node 472, node 472 connected to the input of an inverter 474 that drives one input of the NAND gate 462. Node 472 is connected to one input of the NOR gate 460. A control signal received on a node 475 controls whether a particular port is a push-pull port or an open-drain port. This control signal on line 475 is input to one input of the OR gate 466. If it is a logic “1,” this indicates a push-pull operation such that the gate of transistor 464 is at a logic high, thus disabling transistor 464. The signal on node 475 is also input to one input of the NAND gate 462. The output logic value that drives the port when configured as a digital output is provided on a digital input port 476 to drive both one input of the NAND gate 462 and one input of the NOR gate 460. Therefore, if the value is a logic “1” in the push-pull mode this will drive the node 458 low, turning on transistor 456 and it will drive the gate of transistor 452 low. When a logic “0” is input to input port 476, the output of NAND gate 462 is driven high turning off transistor 456 and the output of NOR gate 460 is driven high, turning on transistor 452 and pulling node 450 to ground. This is a push-pull operation. In the open-drain operation, the control signal node 475 is set at a logic “0” in order to disable transistor 456 and enable OR gate 466. Node 454 is connected to one input of the OR gate 466 such that when a logic “low” is input to input port 476 and the output of NOR gate 460 is driven low, this will disable transistor 464. However, when a logic “1” is input to input port 476, this will force a logic “0” on node 454 which is connected to one input of the OR gate 466. This will cause the output of OR gate 466 to go low, enabling transistor 464 to act as a weak pull up. There is also an input on a line 477 that disables the pull up by putting a logic “1” on the input of OR gate 466 to pull the gate of transistor 464 high. This will utilize an external pull up in that event.

During a receive operation, the crossbar enable signal on node 468 is pulled low, since this is not a digital output. The digital input is provided by a receiver 478 that has the input therefore connected to the output port pin 314 on node 450 and the output thereof provided on a receive output 479. The receiver 478 is controlled by a signal on a node 480 that, when at a logic “1,” would disable the receiver 478, and when at a logic “0,” the receiver would be enabled. Node 480 is connected to the output of an OR gate 482, one input thereof connected to a signal C2_Active, which is the serial input port for receiving serial data for configuration and debug operation. This is associated with the debug/programming hardware block 374. The other input of the OR gate 482 is connected to the output of an AND gate 484, one input thereof connected to a control signal on an input node 485 that defines the port as the digital input and the other input thereof connected through an inverter node to an input node 486, this being the input that allows the port to be configured as an analog port for use with the analog peripherals. The node 480 is also connected to one input of the NOR gate 460 and, through an inverting node, to one input of the NAND gate 462. Therefore, when the node 480 is at a logic “1,” this will force the output of NOR gate 460 on node 454 low, disabling transistor 452 and it will force a logic “0” on the input of NAND gate 462, forcing the output thereof high, disabling transistor 456, such that the port can not drive the signal to the output port pin 314.

Whenever the port is configured as an analog input/output, both the digital receive function and the digital transmit function are disabled. A logic “1” on node 480 disables the receiver 478 and disables transistors 452 and 456. This will also control two analog paths, one controlled by a transfer gate 487 to connect output port pin 314 to an analog peripheral node 488, this being connected to the output of an analog multiplexer block 489. A second transfer gate 490 is provided for connecting output port pin 314 to an N-channel pull-down transistor 491, this being a pull-down. Thus, if transfer gate 490 connects output port pin 314 for the associated output port to the drain of transistor 491, this node will be pulled to ground. As will be described herein above, for a panel scanning operation, prior to the panel scan, all nodes associated with the columns and rows of the panel are pulled to ground. Thereafter, a select one or ones of the nodes will be tested by either self capacitance measurement or mutual capacitance measurement with the remaining nodes being held to ground through this pull-down transistor 491. The node of interest for being tested will then have the transfer gates 490 deactivated during the analog operation and the transfer gate 487 activated such that the analog input or output will be connected to the node 488 and controlled by the multiplexer 489.

The multiplexer 489 is an analog multiplexer associated with the pad that is operable to selectively connect the node 488 to either the MTR Tx line or bus 341, the MTR Rx line 344, the CDC/ADC bus or analog line 332 or to function as a crystal input for interfacing with one terminal of a crystal or to function as an RTC input. As noted herein above, certain ports can not be configured to connect to these particular lines. However, the analog multiplexer block 489 is a pad specific or port specific multiplexer that is capable of being interfaced with all of the associated potential analog signals. It may be that, from a layout standpoint, certain pins would not be connectable to, for example, the MTR Tx bus 341. In that situation, the line would not be run to the associated analog multiplexer. It may even be that certain ports would not have an analog functionality at all such that they would not require the associated T-gates 487 and 490 nor the multiplexer 489. However, for those ports that function both with digital input/output capability and an analog input/output functionality, the input/output circuitry of FIG. 4 will be utilized.

In order to select a particular pad as an analog input/output, the output of the OR gate 482 will be controlled to generate a logic “1.” Thus, one of the inputs to the OR gate 482 needs to be at a logic “1;” either the C2 Active input needs to be high or the output of the AND gate 484 needs to be high. The output of the AND gate 484 is high whenever the input on node 485 is high and the input on node 486 is low. Thus when the port manager generates a logic “1” on the node 485, then the node 480 is controlled by the signal on node 486. This signal can be generated by the CPU or it can be hardware generated by any of the analog peripheral blocks. As will be described herein below, the analog peripherals can operate in the various low power modes wherein the CPU is not operating. These analog peripherals, such as the MTR module 114 and the capacitive sense block 112, are hardware state machines. They can control any one of the particular blocks to function as an analog input/output block and also control which of the two transfer gates 487 and 490 are activated. This function is controlled by a transfer gate control block 494 which provides an AND function (not shown) which ANDs control signals from the respective hardware block to select either one of the transfer gates 487 and 490. As an example, consider the operation of the multi-touch resolve operation. In this operation, certain ones of the pins are controlled to be transmit pins and certain ones of the pins are controlled to be receive pins, as set forth in FIGS. 3a, 3b and 3c. The control operation will, in a first mode, connect all of the respective columns and rows to ground, via global activation of the transfer gate 490. The respective output pads will be configured as analog input/output pads by pulling the node 486 low for those respective pads and then the transfer gates associated therewith will be turned on. In the next step, the panel scanning step, there will be a strobe of one row and all columns connected to ADCs 342 (a parallel sense operation). One row is connected to the MTR Tx line 341 and all of the columns are connected to their respective MTR Rx line on bus 344, it being noted that there will be one input to the associated multiplexer for a pad associated with one of the ADCs 342, this being a layout restraint. Thus, all of the MTR Rx signals will be connected through the T-gate 487 during a panel strobe to the respective MTR Rx bus line on bus 344 and, thus, to their corresponding ADC 342. The remaining row lines that are associated with the MTR Tx functionality will be connected to ground through the respective transfer gate 490. Alternatively, for the self capacitance check, each of the rows or columns in the display are individually selected with the remaining ones connected to ground through the transfer gate 490. Thus, one transfer gate 487 for one pad will be activated for this operation.

Thus, it can be seen that any particular pad can be controlled to provide an output driving signal from an analog signal generator or be connected to receive an analog input. This functionality can be provided in hardware such that a state machine running during the sleep mode of the processor can individually select a particular port for an output signal. As will also be described herein above, one of the output port pins 314 can also be configured as a synch port to provide a synchronization signal for a multi-chip operation. This would allow the state machine to generate a synchronizing edge at a given time for transfer to other chips. All this would require is that the transfer gate 487 for that pad be connected to the synchronizing signal generator, this typically being a logic gate that would output a synchronizing signal to the output that could be connected to other chips. This will be described in more detail herein below.

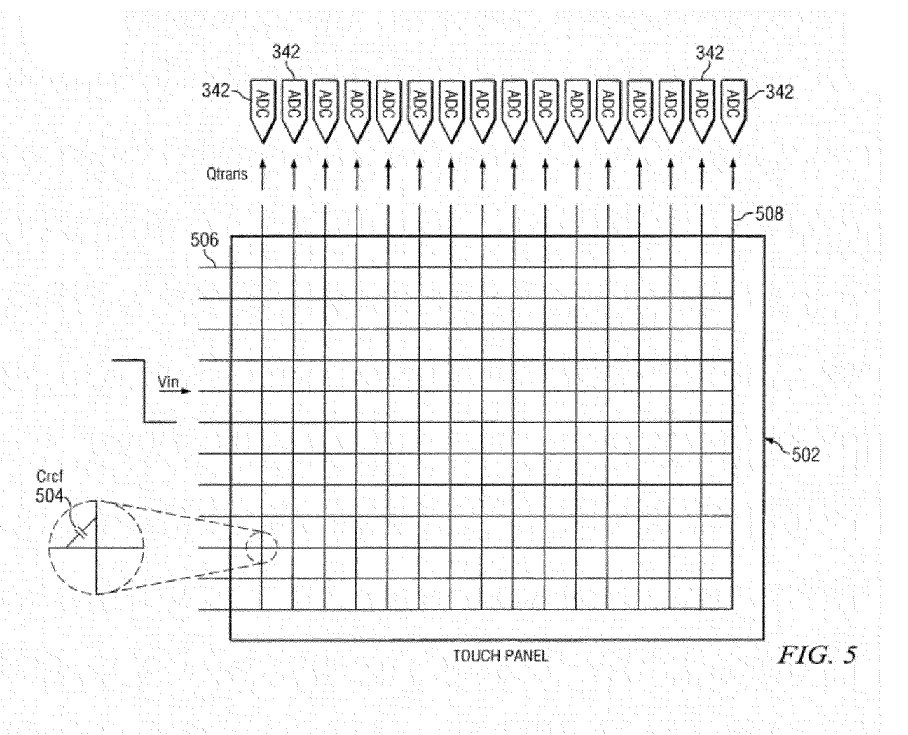

Referring now to FIG. 5, there is illustrated a diagrammatic view of a touch panel 502 representing the touch screen 104. The touch panel 502 is a capacitive touch panel that is comprised of a plurality of transparent row lines and column lines, the row lines being parallel to each other and the column lines being parallel to each other. These row and column lines are electrically isolated from one another and are all transparent. Typically, these conductive lines are formed from Indian Tin Oxide (ITO). This provides a mutual capacitance sensing medium such that, between the intersection of each row line and column line, there exists a row-to-column capacitance (C_{RCF}) 504. The row lines are designated as row lines 506 and the column lines are designated as column lines 508.

As was described herein above, each of the row lines 506 is sequentially driven by a negative going pulse and all of the column lines 508 are output simultaneously to a respective one of the ADCs 342 to allow charge to be transferred from the C_{RCF} associated with the intersection of the driven row line 506 and the respective intersection between that row line 506 and the column line 508. Charge is transferred from C_{RCF} to the respective ADC 342 and a conversion performed to convert that quantum of charge transferred out of C_{RCF} to a digital value, which will be described in more detail herein below. It should be understood that, although the illustration shows the rows being driven and the columns being sensed, it is possible to drive the columns and sense the rows. Thus, creation of a charge on the capacitor 504 followed by transfer of that charge to the ADC 342 allows for evaluation of the value of that charge.

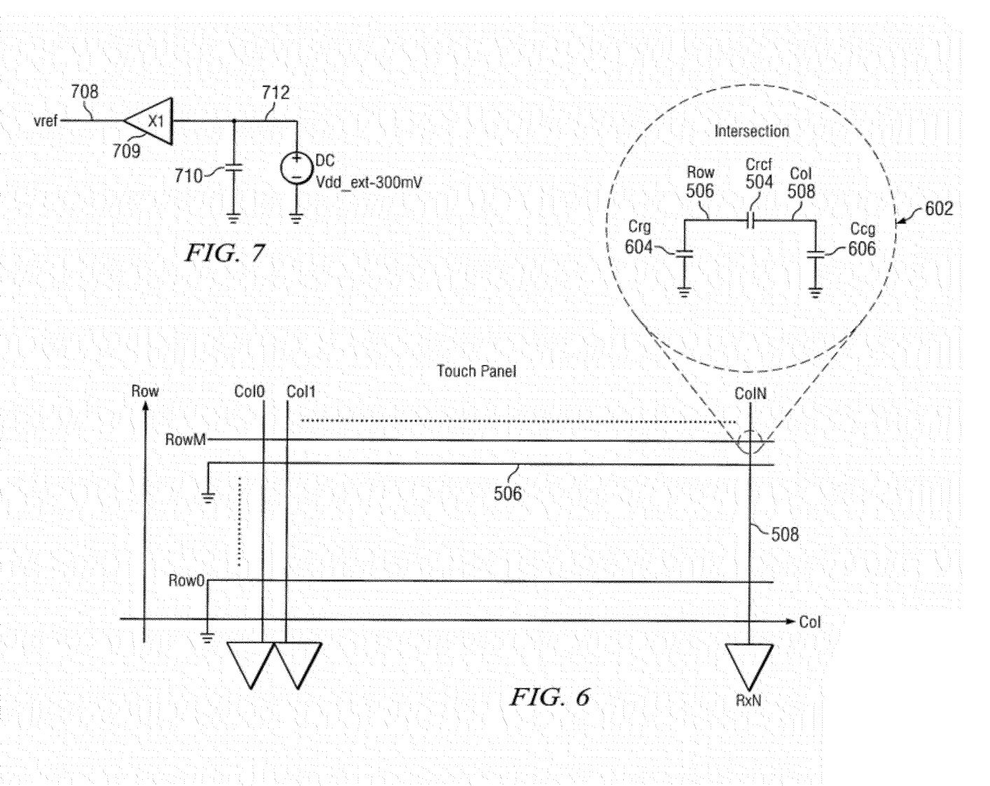

Referring now to FIG. 6, there is illustrated a detail of the touch panel 502 illustrating the intersection of the row lines 506 and the column lines 508 at a point 602. At this point, the circuitry therefor can be simplified as having the C_{RCF} for that intersection disposed between a row-to-ground capacitance (C_{RG}) 604 and the column-to-ground capacitance (C_{CG}) 606. Each of the row lines 506, depending upon the size of the panel, will have a capacitance to ground associated therewith. The larger the panel, the more the capacitance. This is also the case with respect to the C_{CG} capacitance on the column line. The desire is to measure the capacitance change of C_{RCF} whenever a finger touch is present. If there is a finger touch, what will happen is that C_{RCF} will decrease while C_{CG} and C_{RG} increase. Thus, each intersection is scanned such that the change in that the value of capacitance C_{RCF} can be determined. It is noted that the stronger the touch, the stronger the change in capacitance. However, the CPU 302 that evaluates these values will determine from the intersection or intersections that exhibit a change in capacitance whether a finger touch has actually occurred and what that information means. The circuitry associated with the display and the MTR function functions to measure the capacitance, determine if a change has occurred, collect data and inform the CPU 302 of such.

Referring now to FIG. 7, there is illustrated a diagrammatic view for the sampling circuitry for sampling the voltages for the ADC operation. Prior to performing a “conversion” operation wherein the charge from the associated C_{RCF} is transferred to the ADC 342 and converted into a digital value, power noise is minimized. As noted herein above, this particular peripheral block, MTR module 114 associated with the MTR function, is interfaced with the unregulated supply voltage, i.e., the battery voltage. In order to remove the noise, the driving voltage V_{DRV} for the MTR transmitter 340 is a divided and buffered value of V_{REF}. The ADC 342 utilizes this reference voltage on a node 708 that is derived from a sample capacitor 710 through a buffer 709 that samples the DC input voltage from the battery onto a node 712. The switches are not illustrated for the sampling operation for each of the node 712, but they will utilize such. The divided voltage V_{DRV} and the V_{IN} voltage are ratiometric so that the power noise will not be in the final result.

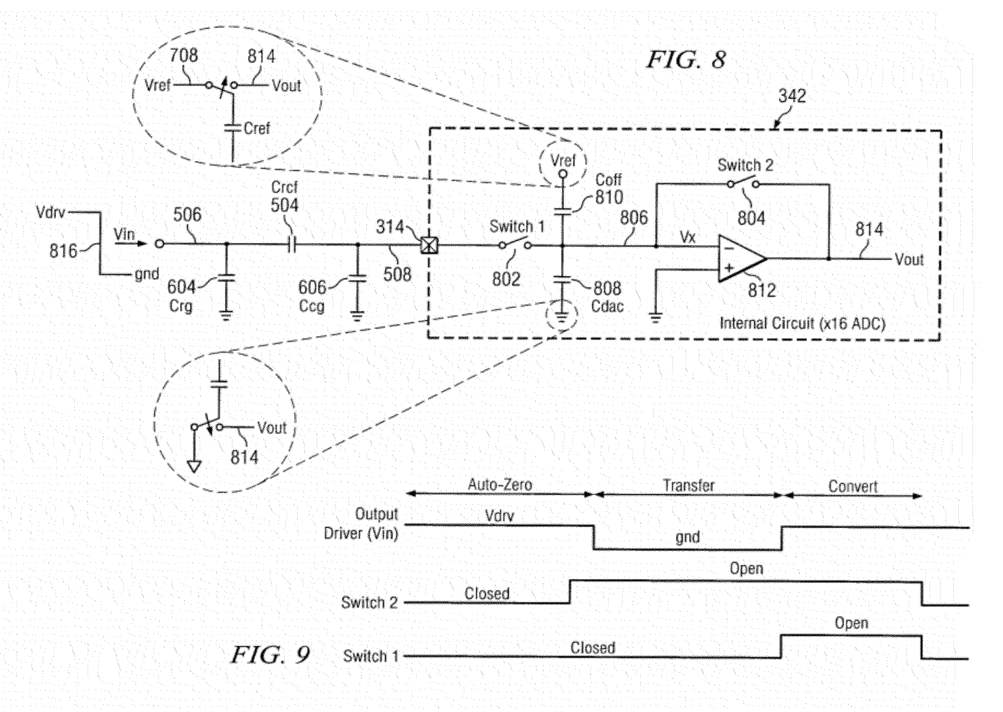

Referring now to FIG. 8, there is illustrated the basic configuration for the ADC 342. External to the chip at one of the pins 314 associated with a particular MTR Rx input, one column line 508 will be associated therewith. A row line 506 will be driven, it being noted that there will be up to sixteen ADCs 342 associated with sixteen column lines 508 that are perpendicular to the one single row line 506 that is being driven with the negative going edge referred to as V_{IN}. The ADC 342 interior to the IC 102 is denoted by a dotted line to indicate that it is interior to the chip. The ADC 342 will be connected to or interfaced to the column line 508 through the output port pin 314. A switch 802 (switch 1) is operable to switchably connect the column line 508 to an internal node 806. Node 806 is connected to one plate of a capacitor 808 labeled C_{DAC} and also to one plate of a reference capacitor C_{OFF} 810. The C_{DAC} capacitor 808 has the other plate thereof connected to ground with the C_{OFF} capacitor 810 having the other plate thereof connected to a voltage V_{REF}. Voltage V_{REF} is the voltage sampled onto the capacitor 710 and node 712 and then output on node 708 by buffer 709. The node 806 is connected to the negative input of an amplifier 812, the positive input thereof connected to ground for illustrative purposes. In general, the positive node will be connected to a common mode voltage in most instances, but this could be ground and is illustrated as such for clarity purposes. It should also be noted that this particular amplifier 812 has an offset voltage. Therefore, the negative input will typically be offset by an offset voltage which, for this embodiment, is approximately 900 mV but can vary depending upon the amplifier circuitry. The switch 804 is connected between the node 806 on the negative input of the amplifier 812 and the output thereof to switchably connect the two together and basically short the negative input to the output to provide a unity gain amplifier. The output is labeled V_{OUT}. The purpose for the capacitor C_{OFF} 810 is to guarantee that the amplifier 812 works in the high gain region for the entire range of C_{RCF} such that any voltage variation across C_{DAC} will not go above or below the rail voltage on the output of the amplifier 812.

The plate of capacitor 810 opposite to node 806 that is illustrated as being connected to V_{REF} is actually switchably connectable between V_{REF} on node 708 and the output of the amplifier on a node or V_{OUT} terminal 814. Thus, the other plate of the capacitor can be connected to two different voltages. Similarly, the other plate of the C_{DAC} capacitor 808, illustrated as being connected to ground, is switchably connectable between ground and the V_{OUT} terminal 814. This will be clarified with the description herein below.

Prior to describing the operation in detail, the general operation will be described. The goal of the operation is to initially charge up both the row line 506 and the column line 508 in what is referred to as an auto zero mode. This occurs at the high side of V_{IN} at a point 816 at level V_{DRV}. Depending upon the size of the display, the value of C_{RG} (capacitor 604) can be rather large. Similarly, the capacitor C_{CG} could also be large. Thus, there is required a certain amount of time for this capacitor to fully charge to the voltage V_{DRV}. This is a programmable length of time. It is noted that, prior to a “strobe” of any portion of the touch screen, all inputs (nodes associated with row lines 506 and column lines 508) are grounded. In order to charge up the node 508, switch 804 (switch 2) is closed such that the unity gain amplifier will drive the negative input. In this configuration, the negative input is essentially disposed at a virtual ground which, if amplifier 812 had no offset, would be the voltage on the positive input thereof. However, with the offset, the negative input will be offset from the positive input by 900 mV in one embodiment, although this offset value is a design choice. In any event, it will be at a fixed voltage which will cause the node 508 to be charged to the virtual ground voltage, referred to as “V_{X},” and this will charge up the column to ground capacitor C_{CG} 606, the C_{DAC} capacitor 808 and the C_{OFF} capacitor 810 to V_{X}. The next step is the sampling or transfer operation wherein the charge from the C_{RCF} capacitor 504 is transferred onto the C_{DAC} and C_{REF} capacitors. To do this, switch 802 is maintained in a closed position but switch 804 is opened and the C_{OFF} and C_{DAC} capacitors are connected in parallel between node 806 and the output of amplifier 812. This will effectively maintain the negative input at the virtual ground level V_{X} that existed when switch 804 was closed. This will keep the column line 508 and the node 806 at the same voltage and then V_{IN} is moved from the V_{DRV} voltage to ground. This will effectively transfer the charge on capacitor 504 to the C_{OFF} and C_{DAC} capacitors. However, it is noted that any analog voltage, when changing from one level to another at one time vs. another will change by substantially the same amount but may vary by a noise component. A conversion operation is then implemented wherein the column line 508 is isolated from node 806 and then the charge difference on the C_{DAC} and C_{OFF} capacitors determined with a successive approximation register (SAR) algorithm to determine a digital voltage representing the difference in charge. By isolating the column line from the ADC 342 during conversion, any noise that might occur during the conversion process will also be isolated. Thus, the operation will entail first charging up the capacitor 504, the C_{RCF} capacitor, with a quantum of charge. This quantum of charge is then transferred onto an internal capacitor or capacitors to change the charge disposed therein. This is followed by a determination of the change in charge. It is this change in charge that correlates to the charge on the capacitor 504. As will be described herein below, since the voltage on node 806 is maintained at the same voltage for the initial auto zero or charging operation of the column line and the charge transfer operation, this column-to-ground capacitor is effectively canceled out from the operation.

Referring now to FIG. 9, there is illustrated a timing diagram for the ADC operation. This ADC operation consists of three phases, an auto zero phase, a transfer phase and a charge to digital conversion phase. The first waveform illustrates the input driver signal that drives the row. This is a signal that is shifted between the drive signal V_{DRV} and ground. Initially, in the auto zero phase, switch 804 (switch 2) is closed and switch 802 (switch 1) is closed. This allows both the column line 508 and the row line 506 to be charged up from the initial ground condition, noting that one row is driven by a Tx pulse, whereas 16 columns are connected to ADCs 342. As noted herein above, the column line is charged to virtual ground V_{X} on the negative input of the amplifier 812. With the offset, this differs from the common mode voltage (or ground) on the positive input of the amplifier 812 by that offset voltage.

In the next phase, the transfer phase, switch 804 (switch 2) is opened and the voltage of V_{IN} driven to ground to transfer charge from the C_{RCF} capacitor (504) to the C_{DAC} and C_{OFF} capacitors. Switch 802 (switch 1) still remains closed. Note that, when switch 804 is open, the opposite plates of C_{DAC} and C_{OFF} which were originally connected to ground and V_{REF}, respectively, will be switched to V_{OUT}. This effectively transfers a charge onto C_{DAC} and C_{OFF}. At the end of the transfer phase, the convert phase is initiated with switch 804 still remaining open. The opposite plates of capacitor C_{DAC} and C_{OFF} from node 806 are again switched to ground and V_{REF}, respectively, after switch 802 (switch 1) opened. During this phase, the amplifier 812 functions as a comparator in a SAR conversion operation, which will be described herein below.

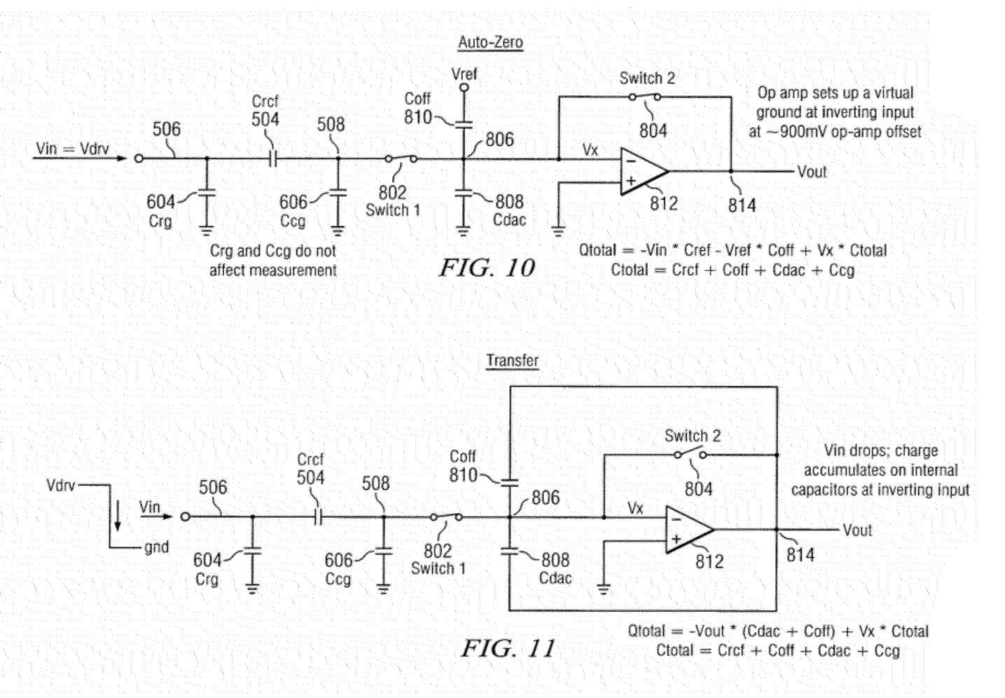

With specific reference to FIG. 10, there is illustrated a configuration for the auto zero phase. In this configuration, switch 804 (switch 2) is closed thus driving the negative input of amplifier 812 on node 806 to virtual ground which will charge node 806 to the virtual ground voltage V_{X}. This will result in a voltage across C_{DAC} of V_{X}, a voltage across C_{OFF} of V_{REF}−V_{X}, a voltage across C_{CG} of V_{X} and a voltage across C_{RCF} of V_{DRV}−V_{X}. The charge on the plate 806 is referred to as the total charge or Qₜₒₜₐₗ. Since the charge across the capacitor is set by the relationship Q=CV, the following relationship will exist for Qₜₒₜₐₗ:

Qtotal=−Vin·Cref−Vref·Coff+Vx·Ctotal

Where:Ctotal=Crcf+Coff+Cdac+Ccg

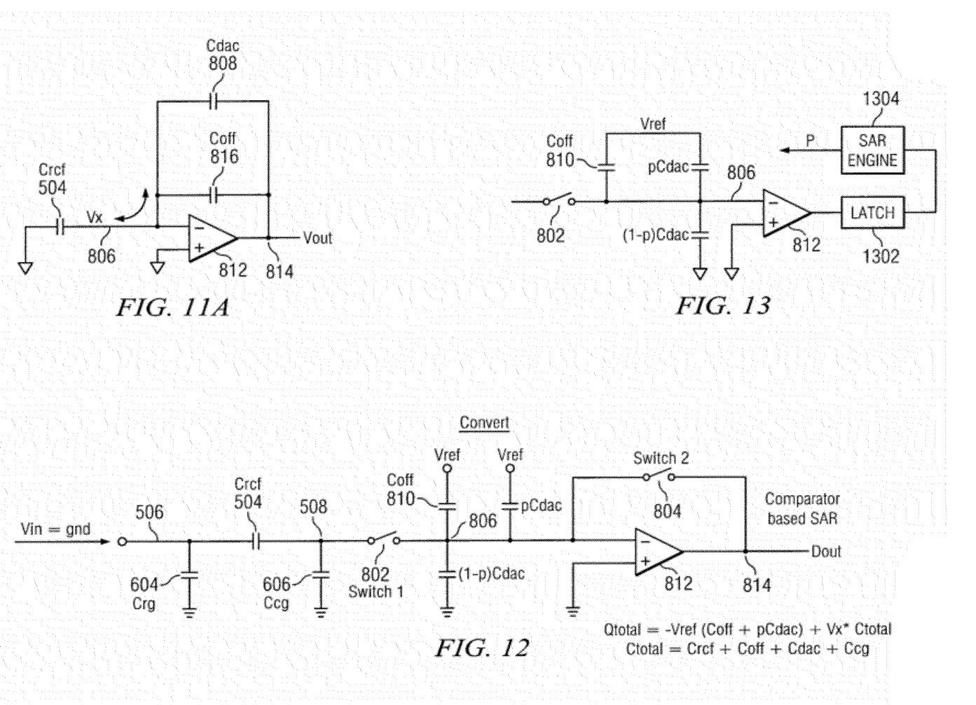

Thus, the amplifier 812 was configured as a unity gain op-amp to basically set up a virtual ground at the inverting input thereof on node 806. The next step is to go to the transfer phase illustrated in FIG. 11. In this phase, switch 2 is opened and the opposite plates of C_{OFF} and C_{DAC} from node 806 are connected to the V_{OUT} terminal 814. Then, V_{IN} is dropped from the V_{DRV} drive level to ground. This will force charge onto the C_{OFF} and C_{DAC} capacitors because the node 806 is at a virtual ground level at voltage V_{X} and is maintained there by the amplifier 812 configured as a feedback amplifier. This will cause the charge on capacitors C_{DAC} and C_{OFF} to change. This is better illustrated in the simplified diagram of FIG. 11a. It can be seen that the charge on the capacitor C_{OFF} and C_{DAC} would be defined by the relationship Q=(V_{O}−V_{X})(C_{DAC}+C_{OFF}) after charge is transferred thereto. The change in C_{RCF} would be changed once V_{IN} was lowered. When V_{IN} is lowered, the charge on the C_{RCF} capacitor 504 is transferred because the voltage across the C_{CG} capacitor 606 has not changed. The result of V_{IN} going from V_{DRV} to ground causes an increase to the charge in C_{RCF}, thus decreasing the charge in C_{OFF} and C_{DAC}. The following relationship exists with respect to the total charge on the node 806:

Qtotal=−Vout·(Cdac+Coff)+Vx·Ctotal

Where:Ctotal=Crcf+Coff+Cdac+Ccg

After the defined time during which the charge will transfer, the conversion operation is then entered, this being a SAR conversion operation. Prior to the conversion operation, however, switch 802 is opened to isolate the column line 508 from the ADC 342 such that any external noise will not affect the conversion operation. Since the charge has already been transferred to C_{OFF} and C_{DAC}, all that remains is to determine the amount of charge transferred thereto.

During the conversion operation, the switches that switch the opposite plates of C_{DAC} and C_{OFF} to V_{OUT} are reconnected to ground and V_{REF}, respectively, such that the capacitors are in substantially the same condition as the auto zero phase noting that analog ground for different components connected to different grounds, i.e., on-chip, off-chip, etc., can have various noise components associated therewith and there may be slight differences. Initially, C_{DAC} at full value is connected between node 806 and ground. The amplifier 812 is now in an open loop configuration such that it is no longer operating as an op-amp and, thus, does not hold the inverting input thereof at the virtual ground level, what will occur is that the voltage on node 806 will change, i.e., it will not be at V_{X}. Thus, the output of the amplifier 812, it now functioning as a comparator, will be high or low. What then occurs is that the value of C_{DAC} is ratioed such that a portion thereof will be connected from node 806 to V_{REF}. The capacitor C_{DAC} is set at a value of approximately 5 pF which is essentially the approximate full range value of the row-to-column capacitance C_{RCF}. It is configured utilizing a plurality of unit caps of value “C” connected in parallel to provide a 5 bit binary set of capacitors, i.e., capacitors C, 2C, 4C, 18C and 16C, and a 5-bit thermometer code utilizing 32 unit caps of value. These can be configured such that the portion of C_{DAC} that is connected between node 806 and ground will have a value of (1−p)C_{DAC} and the portion of C_{DAC} connected between node 806 and V_{REF} will be pC_{DAC}. It can be seen that if p=0, this would indicate that the value of C_{RCF} would be equal to zero. This would be expected in that no change in the charge across C_{DAC} and C_{OFF} existed and, therefore, the voltage on node 806 would essentially be V_{X}, a voltage right at the trigger point for amplifier 812 configured as a comparator. When C_{RCF} is not zero and has some charge stored therein, and charge has been transferred, the SAR algorithm will vary the value of p until the voltage on node 806 is approximately equal to V_{X}, the trip voltage. At this point, there will be a digital value associated with the value of p which will equal the digital value corresponding to the charge on C_{RCF}. Thus, what has been achieved is an analog-to-digital converter that converts charge to a digital value. It is a charge-to-data converter in essence. The relationship for Qₜₒₜₐₗ for node 806 during the conversion operation is, for the configuration illustrated, as follows:

Qtotal=−Vref·(Coff+pCdac)+Vx·Ctotal

Where:Ctotal=Crcf+Coff+Cdac+Ccg

Another way to describe the way in which the charge is present on the various capacitors and nodes is to calculate the charge in a different manner. Referring back to FIG. 10 and the auto zero mode, it can be seen that the common plate charge on node 806 will be as follows:

Qaz=Vx·Cdac+(Vx−Vref)·Coff+(Vx−Vdrv)·Crcf+Vx·Ccg

This takes into account the charge across each of the C_{RCF}, C_{CG}, C_{DAC} and C_{OFF} capacitors.

Then, following through to FIGS. 11 and 11a, it can be seen that, when the voltage on the row line is pulled from V_{DRV} to ground, the common plate charge on node 806 will be defined as follows:

Qxfer=(Vx−Vo)·CDAC+(Vx−Vo)·Coff+Vx·Crcf+Vx·Ccg

Since the total charge has not changed but, rather, has merely been shifted from C_{RCF} to C_{DAC} and C_{OFF}, the other relationship Q_{az}=Q_{xfer} will be valid. With this equality, and substituting in the equations for Q_{az} and Q_{xfer}, the following relationship will result:

Crcf·Vdrv=Cdac·Vo+Coff·(Vo−Vref)

This will result in the following relationship with respect to the output voltage of the amplifier 812:

$$Vo = \frac{Coff \cdot Vref + Crcf \cdot Vdrv}{Cdac + Coff}$$

In the conversion phase, illustrated in FIG. 12, the two capacitor values will be C_{OFF} and pC_{DAC} connected between node 806 and V_{REF} and (1−p) C_{DAC}, disposed between node 806 and ground. The relationship for the common plate charge on node 806 at the end of the SAR conversion phase where the voltage on the inverting input of the amplifier 812 will be essentially equal to the trip point which is V_{X}, i.e., the virtual ground voltage. The plate charge on node 806 in the configuration of FIG. 12, wherein the node 806 is disposed at V_{X} at the end of the SAR conversion process and the capacitors C_{OFF} and pC_{DAC} are connected between node 806 and V_{REF} and the capacitor (1−p) C_{DAC} is connected between node 806 and ground, should be identical to the charge that was stored on C_{OFF} and C_{DAC} when they were connected in feedback with amplifier 812 in FIG. 11 and FIG. 11a. Thus, the following relationship will represent that equality:

Cdac·Vx(1−p)+pCdac·(Vx−Vref)+(Vx−Vref)Coff=(Vx−Vo)(Cdac+Coff)

Upon reducing the above equation, the following relationship will exist:

p·Cdac·Vref=Cdac·Vo+Coff(Vo−Vref)=Crcf·Vdrv

which will yield:

$$p = \frac{Crcf \cdot Vdrv}{Cdac \cdot Vref}$$

It can be seen from the previous equation that, if C_{RCF} is set equal to zero, the value of p will be set equal to zero, which shows that there will be no distribution of charge. If C_{RCF} is equal to C_{DAC}, and V_{DRV} is equal to V_{REF}, then the value of the capacitor C_{DAC} disposed between node 806 and ground would be equal to zero, since p=1.

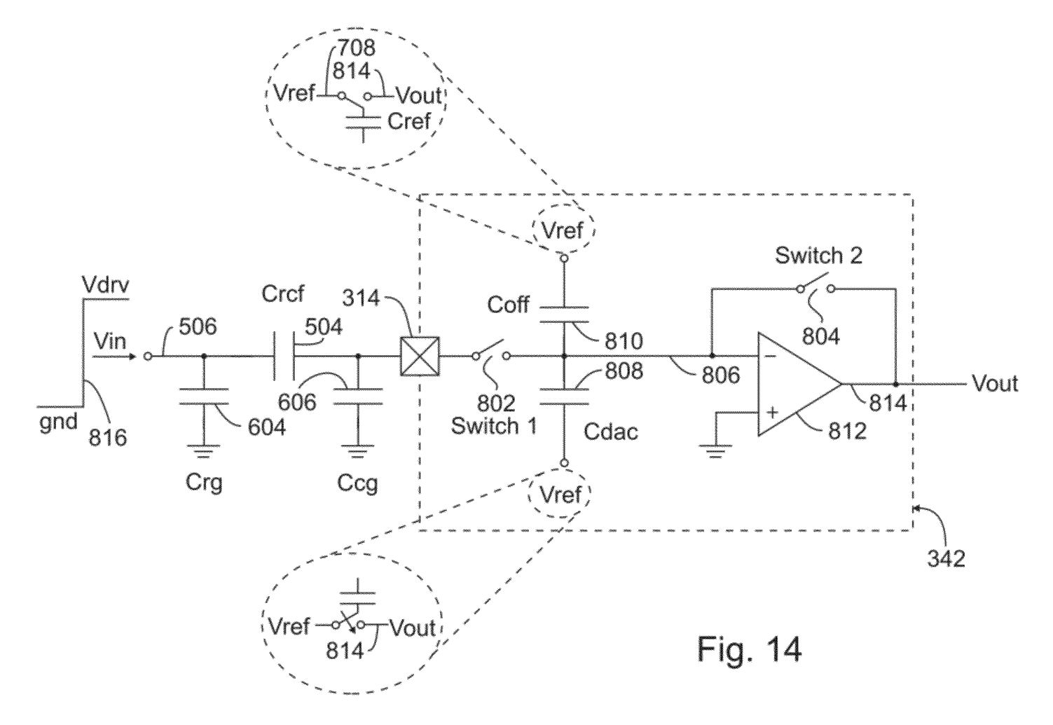

Referring now to FIG. 13, there is illustrated a diagrammatic view of the SAR engine during the conversion phase. During this phase, the amplifier 812 is configured as a comparator and switch 802 (switch 1) is open, thus isolating node 806 from the array and, thus, preventing any noise from being passed across switch 802 from the array. C_{DAC}, as described herein above, is comprised of multiple capacitors such that a portion of the capacitor C_{DAC} can be disposed between node 806 and ground and a portion can be disposed between node 806 and V_{REF}. The output of amplifier 812 is input to a latch 1302, the output thereof utilized by a SAR engine 1304 to generate the value of “p.” The C_{DAC} capacitor is comprised of a 5-bit binary capacitor section and a 5-bit thermometer section. The binary section is comprised of a combination of unit capacitors which stores a value “C” such that the capacitors in the 5-bit binary array are C, 2C, 4C, 8C and 16C, resulting in 31 unit capacitors. The thermometer portion will have 2⁵−1 capacitors or 31 capacitors of size 32C. This type of DAC is usually referred to as a hybrid DAC wherein the thermometer coded bits are associated with the five most significant bits and the binary weighted bits are associated with the five least significant bits. With the binary weighted portion of the DAC, elements corresponding to the more significant bits are weighted higher than elements corresponding to the less significant bits. With respect to the thermometer coded DAC portion, the number of asserted bits in the thermometer code would be proportional to the value of the digital signal and each bit of the thermometer code is provided to a corresponding capacitor. A binary to thermometer decoder is utilized to generate the thermometer code from the binary code.

During the SAR operation, the first step will be to assert the most significant bit and determine if node 806 is at or below the trip point. As described herein above, the trip point will be the virtual ground which is basically the voltage offset from the positive input voltage. Even though this voltage is illustrated as being connected to circuit ground, it would typically be connected to a common mode voltage generated on-chip. Thus, when the voltage goes above the trip point, the output of amplifier 812 will go negative and, when it is below the trip point, the output will go positive. The SAR engine 1304 will test each bit to determine if the voltage on node 806 is above or below the trip point. If it is below the trip point, that bit will be maintained as a latched value and then the next value tested, such that each lower MSB can be tested in sequence. If the next MSB causes the voltage to go above the trip point, this bit is maintained at a logic “0” for the value “p.” At the end of the SAR operation, after 10 bits, the value will be latched and this will constitute the result. What this value indicates is a digital value corresponding to the charge that was transferred to C_{OFF} and C_{DAC}. As noted herein above, if the value of the transferred charge were “0,” there would have been no change in the charge stored on C_{OFF} and C_{DAC} and the voltage on node 806 in that situation would have been equal to the trip point voltage (the virtual ground voltage) and the result would be that value of “p” would be equal to zero. Thus, by transferring the charge to the capacitors C_{OFF} and C_{DAC} and then isolating node 806 from the array, a conversion can be made to a digital value that represents the charge on C_{RCF}. This is thus a data converter that converts charge to a digital value or a charge-to-digital converter.

The value output by the ADC 342 is utilized to determine whether there has been a change in the capacitance value or the charge stored on the capacitor. In the presence of a touch, the column to ground capacitance will increase and the column-to-row capacitance (C_{RCF}) will decrease. If the decrease is beyond a certain threshold, a decision can be made that this is a “touch” condition. However, scanning of an array will usually result in a no-touch decision since the display is idle a large percentage of the time with respect to the user interface thereto. Thus, it is the desire to minimize the amount of power required to make the determination that there is a “no-touch” condition.

To determine that there is a touch one compares a current value of C_{RCF} to a prestored value representing the no-touch situation. This is referred to as the “baseline value.” The baseline value for each of the C_{RCF} capacitors in the array will be determined during a calibration operation. This calibration operation can be user initiated or it can be automatically based on time or even temperature. When the temperature of the device containing the touch screen and the chip changes, this can change the values of the capacitor C_{RCF} and, therefore, there will be some type of calibration.

As will be described herein below, there are multiple modes of operation of the chip to conserve power. One of the largest sources of power consumption on the chip is the operation of the controller core or CPU 302 and the digital circuitry associated therewith, the operation referred to as the MCU operation. When the MCU is active and executing instructions, the current draw will go up significantly. Thus, the entire chip has the ability to operate in different modes of operation to, for example, stop execution of the controller core or CPU 302, suspend operation of the system clock block 376 and even remove power from a large portion of the digital circuitry. There are defined multiple modes. One mode is the active mode which is a mode wherein the system clock block 376 is operating to generate the system clock, the controller core or CPU 302 is executing instructions and, in essence, the MCU is fully functioning. There can be multiple modes, there being an active mode, a normal mode and a low power mode. In the normal mode, everything is functioning. In the low power mode, certain select aspects of the digital circuitry can be turned off. For example, if the SMBus is not being accessed, it is not necessary to clock that peripheral. The clock generator block or system clock block 376 has a clock generator 388 that can generate the various peripheral clocks. As will be described herein below, these peripheral clocks are generated in response to a request for a clock signal thereto. The circuitry for generating the clock is not activated until such request is made.

A second mode is an idle mode. In the idle mode, the execution operation for the controller core or CPU 302 is halted but digital power is maintained thereto. The operation of the system clock can also be suspended. When the system comes out of idle mode to active mode, the CPU 302 will begin servicing the various interrupts, etc., that have requested to be serviced and the programs run that are associated with the requests. However, the digital power is maintained in the idle mode. Once digital power is removed, the CPU 302 will effectively have to boot up when the LDO portion of the regulator 364 is again brought up to power. This can take time and consume unnecessary power. Therefore, the CPU 302 in the idle mode will be in a ready condition. There is also the sleep mode wherein the digital portion is essentially powered down but portions of the chip can remain operational. Typically, the RTC or smart clock block 386, the I²C block 358 and other portions of the circuitry such as a function termed “port match” will operate. These are analog peripherals in the analog peripheral block 312. As noted herein above, the MTR module 114, the CDC 112 and the I²C block 358 are self-clocked such that they can operate outside the presence of the system clock generator block 376 or the CPU 302 in operational mode. An interrupt will “wake up” the CPU 302. Since most scans will result in a no-touch determination, it is desirable to minimize the amount of digital power that is applied to the digital portion of the circuitry. It is noted that the MTR MODULE 114 operates in the idle mode, but not the sleep mode.

FIGS. 14-16 illustrate MTR chopper apparatus and related techniques according to other embodiments. Similar to the above description, the MTR chopper uses the auto-zero, transfer, and convert modes of operation. The MTR chopper seeks to reduce effects of various types of interference. One type of interference is power-line interference, which typically occurs at the power-line frequency (e.g., 50 Hz, 60 Hz, 400 Hz) or relatively low-order harmonics of the power-line frequency (e.g., 120 Hz or 180 Hz for a 60 Hz mains frequency).

Another type of interference relates to parasitic effects or “ghost finger” effects. This effect refers to currents produced by changes in capacitance (rather than changes in voltage). Specifically, the effect involves an object, such as a finger, approaching the touch screen capacitances (any capacitances coupled to a row in the touchscreen). The approaching object or finger induces currents in one or more rows of the touchscreen. The current(s) may enter IC 102 and be interpreted as a capacitance change.

Note that the interference mechanisms described above are relatively slow changing compared, for example, to the conversion rate of the MTR) phenomena, and therefore cause relatively slow-changing interference voltages and currents. In other words, the changes in the interference effects (changes in current(s) and/or voltage(s)) are typically negligible from one conversion cycle of the MTR to the next conversion cycle. Thus, the MTR chopper apparatus can differentiate between changes caused by a “real” finger (e.g., when the user touches the touchscreen) and changes caused by interference. Because of this capability, the MTR chopper can provide more robust functionality.

The following description provides details of the operation of the MTR chopper. FIG. 14 illustrates a basic diagram for the ADCs associated with the MTR chopper function. Referring now to FIG. 14, there is illustrated the basic configuration for the ADC 342. External to the chip at one of the pins 314 associated with a particular MTR Rx input, one column line 508 will be associated therewith. A row line 506 will be driven, it being noted that there will be up to sixteen ADCs 342 associated with sixteen column lines 508 that are perpendicular to the one single row line 506 that is being driven with the positive going edge referred to as V_{IN}. The ADC 342 interior to the IC 102 is denoted by a dotted line to indicate that it is interior to the chip. The ADC 342 will be connected to or interfaced to the column line 508 through the output port pin 314.

A switch 802 (switch 1) is operable to switchably connect the column line 508 to an internal node 806. Node 806 is connected to one plate of a capacitor 808 labeled C_{DAC} and also to one plate of a reference capacitor C_{OFF} 810. The C_{DAC} capacitor 808 has the other plate thereof connected to V_{REF} with the C_{OFF} capacitor 810 having the other plate thereof connected to V_{REF}. Voltage V_{REF} is the voltage sampled onto the capacitor 710 and node 712 and then output on node 708 by buffer 709. The node 806 is connected to the negative input of an amplifier 812, the positive input thereof connected to ground for illustrative purposes. In general, the positive node will be connected to a common mode voltage in most instances, but this could be ground and is illustrated as such for clarity purposes. It should also be noted that this particular amplifier 812 has an offset voltage. Therefore, the negative input will typically be offset by an offset voltage which, for this embodiment, is approximately 900 mV but can vary depending upon the amplifier circuitry. The switch 804 is connected between the node 806 on the negative input of the amplifier 812 and the output thereof to switchably connect the two together and basically short the negative input to the output to provide a unity gain amplifier. The output is labeled V_{OUT}. The purpose for the capacitor C_{OFF} 810 is to guarantee that the amplifier 812 works in the high gain region for the entire range of C_{RCF} such that any voltage variation across C_{DAC} will not go above or below the rail voltage on the output of the amplifier 812.

The plate of capacitor 810 opposite to node 806 that is illustrated as being connected to V_{REF} is actually switchably connectable between V_{REF} on node 708 and the output of the amplifier on a node or V_{OUT} terminal 814. Thus, the other plate of the capacitor can be connected to two different voltages. Similarly, the other plate of the C_{DAC} capacitor 808, illustrated as being connected to V_{REF}, is switchably connectable between ground and the V_{OUT} terminal 814. This will be clarified with the description herein below.

Generally, the circuit in FIG. 14 has the same configuration as the circuit in FIG. 8, with the following exceptions. During the auto zero mode or phase, the voltage V_{IN} (applied to node 506) is at a low level (ground potential). Furthermore, capacitor C_{DAC} has one plate coupled to node 806 and the other plate coupled to voltage V_{REF}. During the charge transfer mode, the voltage V_{IN} makes a transition from the low level (ground potential) to the high level (V_{DRV} or, generally, to a level higher than the ground potential). The conversion mode remains unchanged for MTR chopper functionality, i.e., it remains as described above with respect to the MTR function. Note, however, that because of the changes noted above between the MTR and MTR chopper functions, the digital result of the conversion mode for the MTR chopper is the logical complement of the digital result for the MTR. Thus, either the follow-on circuitry is changed to account for the inversion, or the processing of the results is changed to take into account the inversion.

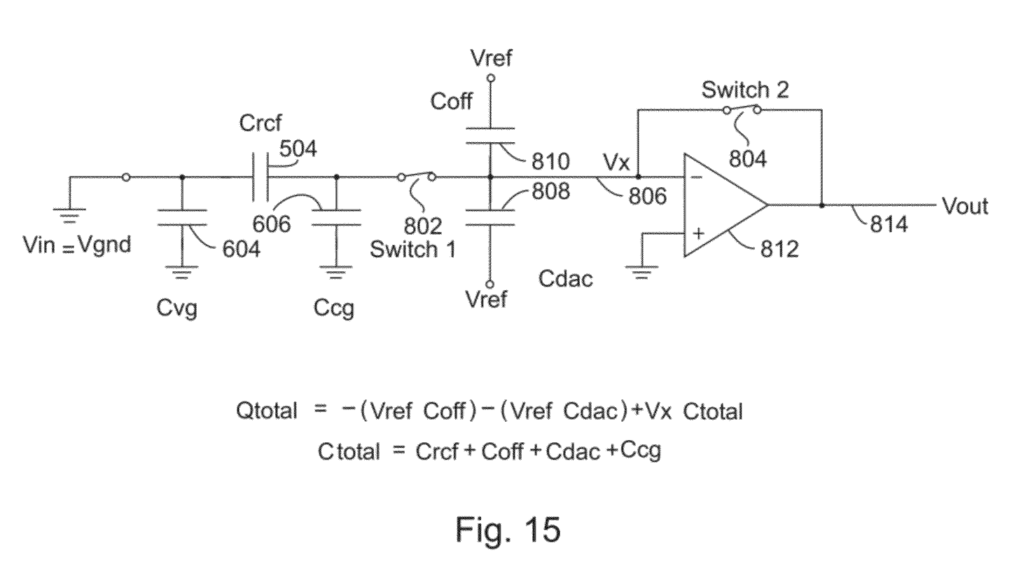

With specific reference to FIG. 15, there is illustrated a configuration for the auto zero phase. In this configuration, the input voltage V_{IN} is at the low level (ground potential). Also, switch 804 (switch 2) is closed thus driving the negative input of amplifier 812 on node 806 to virtual ground which will charge node 806 to the virtual ground voltage V_{X}. This will result in a voltage across C_{DAC} of V_{REF}−V_{X}, a voltage across C_{OFF} of V_{REF}−V_{X}, a voltage across C_{CG} of V_{X} and a voltage across C_{RCF} of −V_{X}. Thus,

Qtotal=−(V_{ref}C_{off})−(V_{ref}−Cdac)+VₓCₜₒₜₐₗ,

where Cₜₒₜₐₗ=C_{ref}+C_{off}+C_{dac}+C_{cg}.

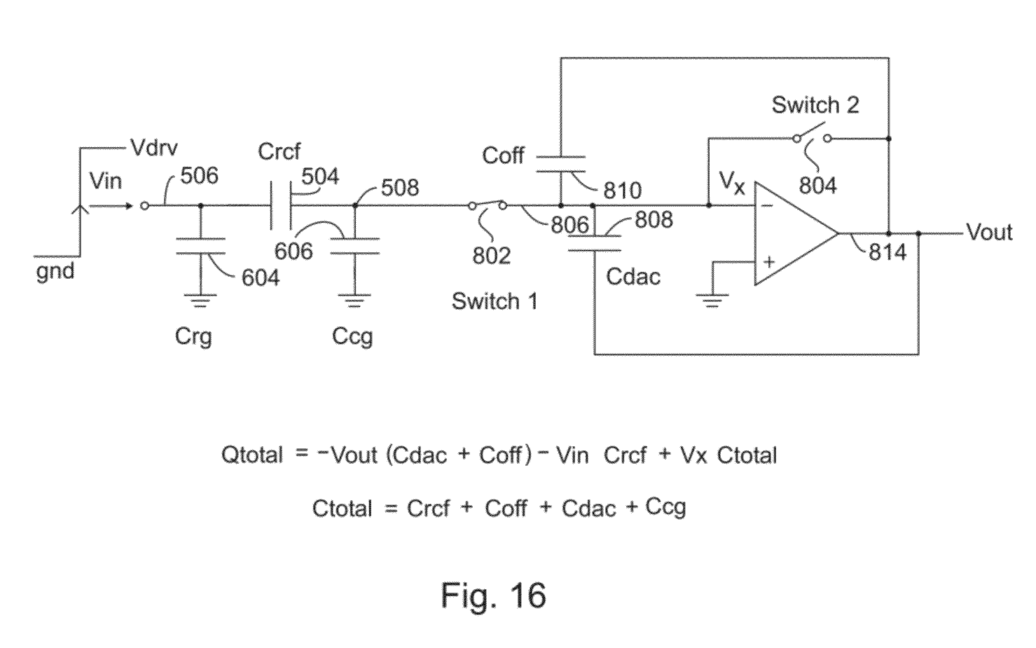

Thus, the amplifier 812 was configured as a unity gain op-amp to basically set up a virtual ground at the inverting input thereof on node 806. The next step is to go to the transfer phase illustrated in FIG. 16. In this phase, switch 2 (labeled 804) is opened and the opposite plates of C_{OFF} and C_{DAC} from node 806 are connected to the V_{OUT} terminal 814. Then, V_{IN} is raised from ground to the V_{DRV} drive level. This will cause the charge on capacitors C_{DAC} and C_{OFF} to change. The charge on the capacitor C_{OFF} and C_{DAC} would be defined by the relationship Q=(V_{O}−Vₓ)(C_{DAC}+C_{OFF}) after charge transfer. The charge in C_{RCF} would be changed once V_{IN} is raised. When V_{IN} is raised, the charge on the C_{RCF} capacitor 504 is transferred because the voltage across the C_{CG} capacitor 606 has not changed. The result of V_{IN} going from ground to V_{DRV} causes an decrease to the charge in C_{RCF}, thus increasing the charge in C_{OFF} and C_{DAC}. The following relationship exists with respect to the total charge on the node 806:

Qtotal=Vₒᵤₜ(C_{dac}+C_{off})−VᵢₙC_{rcf}+VₓCₜₒₜₐₗ,

where Cₜₒₜₐₗ+C_{ref}+C_{off}+C_{dac}C_{cg}.

After the defined time during which the charge will transfer, the conversion operation is then entered, this being a SAR conversion operation. Prior to the conversion operation, however, switch 802 is opened to isolate the column line 508 from the ADC 342 such that any external noise will not affect the conversion operation. Since the charge has already been transferred to C_{OFF} and C_{DAC}, all that remains is to determine the amount of charge transferred thereto.

After the defined time during which the charge will transfer, the conversion operation is then entered, this being a SAR conversion operation. Prior to the conversion operation, however, switch 802 is opened to isolate the column line 508 from the ADC 342 such that any external noise will not affect the conversion operation. Since the charge has already been transferred to C_{OFF} and C_{DAC}, all that remains is to determine the amount of charge transferred thereto.

The conversion phase of the MTR chopper is the same as or similar to the conversion phase of the MTR function, which is described above in detail. As mentioned above, because of the changes noted above between the MTR and MTR chopper functions, the digital result of the conversion mode for the MTR chopper is the logical complement of the digital result for the MTR. Thus, either the follow-on circuitry is changed to account for the inversion, or the processing of the results is changed to take into account the inversion.

Other aspects of capacitance sensor circuitry and system may be implemented and applied to the foregoing embodiments by making modifications to the description provided in the parent application, U.S. patent application Ser. No. 12/870,844, referenced above. Such aspects include the power domain architecture, touch and no touch processing, controllers, interface circuitry, clock generator, clock control flows, and clock synchronization circuitry. The modifications fall within the knowledge of persons of ordinary skill in the art.

It will be appreciated by those skilled in the art having the benefit of this disclosure that this touch screen scanning architecture provides a lower power operation by utilizing hardware scan controllers in combination with an MCU engine. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

1. A method of interfacing with a capacitive touch screen, the method comprising:
charging an internal capacitor in the touch screen, which internal capacitor is disposed proximate a fixed location on the touch screen and is capable of changing in value in response to a touch at the fixed location; and
determining the value of the charge on the internal capacitor,
wherein the value of the charge on the internal capacitor is determined in a manner to reduce effects of interference.

2. The method of claim 1, further comprising comparing the value of the determined charge with a reference value which corresponds to a no-touch condition to determine if the value of the determined charge has changed from the reference value, which is representative of a touch condition.

3. The method of claim 1, wherein determining the value of the charge comprises transferring charge in a transfer operation from the internal capacitor in the touch screen and then determining the value of the charge in isolation of the internal capacitor.

4. The method of claim 3, wherein determining the value of the charge comprises transferring the charge from the internal capacitor to a reference capacitor disposed at a reference charge prior to the transfer operation and, after transferring, determining the change in charge on the reference capacitor, the change in charge corresponding to the charge stored in the internal capacitor.

5. The method of claim 4, further comprising converting the change in charge to a digital value.

6. The method of claim 1, wherein the touch screen is comprised of row lines and column lines arranged in an intersecting relationship to each other and electrically isolated from one another and the internal capacitor comprises a mutual capacitance between the intersection of one of the row lines and one of the column lines.

7. The method of claim 6, further comprising coupling one of the row or column lines to a driving voltage that can change in voltage level from an initial value to a charge transfer value and coupling an intersecting other of the row or column lines to a reference capacitor disposed at a voltage different than the initial voltage and the determining operation comprising changing the voltage level of the driving voltage from low to high and transferring the charge on the internal capacitor in a transfer operation to the reference capacitor, and then determining the change in charge thereon as the value of the transferred charge on the internal capacitor.

8. The method of claim 6, wherein each of the intersections between row and column lines has an internal capacitance associated therewith an associated mutual capacitance and the charging operation comprises:
selecting one of the row or column lines;
generating a charging signal; and
driving the selected one of the row or column lines with a charging signal to store charge on at least one of the internal capacitors associated with the intersection of the selected one of the row or column lines and an intersecting other of the column or row lines.

9. The method of claim 7, wherein driving the selected one of the row or column line charges all of the internal capacitors associated with such driven selected one of the row or column lines and the determining operation comprises determining the value of the charge on each of the internal capacitors associated with each of the other of the column or row lines intersecting with the driven selected one of the one of the row or column lines.

10. The method of claim 8, further comprising controlling the operation of driving to sequentially drive each of the selected one of the row or column lines and storing the determined charge after determining the value of the charge transferred.

11. A method of determining a value of a capacitance between a row line and a column line in a capacitive touch screen comprising a plurality of intersecting row and column lines, the method comprising:
driving one of the row or column lines to a first voltage, with an intersecting one of a column or row lines being coupled to a node external to the touch screen to charge a capacitance at the intersection, the external node having a reference capacitor disposed thereon charged to a reference voltage;
driving the one of the row or column lines to a second voltage higher than the first voltage, and allowing charge to be transferred between the capacitance at the intersection and the reference capacitor; and
determining the value of the change of the charge on the reference capacitor.

12. The method of claim 11, further comprising storing the determined value.

13. The method of claim 11, further comprising isolating the external node from the touch screen prior to determining the value of the change in charge on the reference capacitor.

14. The method of claim 11, wherein determining the value of the change in charge on the reference capacitor comprises converting the determined value to a digital value with an analog-to-digital converter.

15. The method of claim 11, wherein driving the one of the row or column lines and determining the value of the change in charge on the reference capacitor are repeated a plurality of times preceded by discharging the capacitance, and the determined values for each repeated operation is averaged such that changes in the charge due to external noise or perturbations can be averaged between repeated operations.

16. A capacitance value sensor for determining a capacitance value corresponding to the value of a display capacitance in a touch screen display having intersecting first lines and second lines, with the display capacitance disposed at the intersection of one of the first and second lines, the capacitance value sensor comprising:
a driver that drives the one of the first lines to drive one plate of the display capacitance from a first voltage to a second voltage level larger than the first voltage; and
a capacitance sense circuit, including:
a reference capacitor, having one plate thereof coupled to a voltage node;
a charging circuit operating in a first mode to couple the voltage node to the one of the second lines with the driver operating to drive the one plate of the display capacitance to the first voltage level;
charge transfer circuitry operating in a second mode to transfer charge from the display capacitance to the reference capacitor; and
a charge detect circuit operating in a third mode to determine the change in charge on the reference capacitor after transfer of charge thereto from the display capacitance, and to output a value for such change in charge that corresponds to the value of the display capacitance.

17. The capacitance value sensor of claim 16, further comprising an isolation circuit for isolating the display capacitance from the voltage node prior to the third mode of operation.

18. The capacitance value sensor of claim 16, wherein the charging circuit comprises a unity gain operational amplifier for charging the reference capacitor to a virtual ground voltage.

19. The capacitance value sensor of claim 16, wherein the first voltage comprises a ground potential.

20. The capacitance value sensor of claim 16, further comprising a capacitor having one plate thereof coupled to the voltage node, and having another plate thereof coupled to the reference voltage.
